(19) United States
(12) Patent Application Publication
(10) Pub. No.: US 2016/0041747 A1
(43) Pub. Date: Feb. 11, 2016

(54) COMPUTER USER INTERFACE APPARATUS, AND PARAMETER CONTROL METHOD AND NON-TRANSITORY STORAGE MEDIUM

(71) Applicant: Konami Digital Entertainment Co., Ltd., Tokyo (JP)

(72) Inventor: Koki Maekawa, Minato-Ku (JP)

(21) Appl. No.: 14/920,759

(22) Filed: Oct. 22, 2015

Related U.S. Application Data
(63) Continuation of application No. PCT/JP2014/055048, filed on Feb. 28, 2014.

(30) Foreign Application Priority Data
Apr. 26, 2013 (JP) 2013-094002

(51) Int. Cl. G06F 3/0484; G06F 3/0488; G06F 3/16; G06F 3/0486

(52) U.S. Cl. CPC G06F 3/04847; G06F 3/0486; G06F 3/0488; G06F 3/165

(57) ABSTRACT

Provided is a user interface apparatus capable of controlling a change speed of a parameter with respect to a user's setting operation. A gauge volume is set according to the setting operation, such as a drag operation, accompanying with change of an operated position Pa operated by the user. The user interface apparatus is provided with a device which is configured to change the set value Pg of the gauge volume according to the change amount ΔY of the operated position Pa, and in the device further provided is a device which is configured to change according to the elapsed time t from a predetermined reference time set in relation to the setting operation, a criterion value Vc which determines the relation between the change amount ΔY of the operated position and the change amount of the set value Pg of the gauge volume.

### CROSS-REFERENCE TO RELATED APPLICATION

This application is a continuation of PCT Application No. PCT/JP2014/055048, filed Feb. 28, 2014, which claims priority to Japanese Patent Application No. 2013-094002, filed Apr. 26, 2013, the disclosures of which are hereby incorporated by reference in their entirety.

### TECHNICAL FIELD

The present invention relates to a user interface apparatus and the like preferable for setting parameters to be referenced in arithmetic processing of a game machine.

### BACKGROUND ART

As a computer user interface apparatus, widely prevalent is a user interface that employs as an input device, a touch panel device which detects a position where a user is touching or a motion detecting device which detects a motion of a user with a camera, and sets parameters, which are referenced in arithmetic processing, according to operations by the user detected by the input device. For example, as a user interface apparatus for a game machine, suggested is an apparatus that sets parameters of a moving speed and a revolving speed of a character based on change amounts of distance and angle between two points specified on a touch panel by the user. (See Patent Document 1)

### CITATION LIST

### Patent Literature

PTL1: JP-A-2010-029711.

### SUMMARY OF INVENTION

### Technical Problem

In such a conventional user interface apparatus, it is general that set values of the parameters are changed according to the change of an operated position by a user. In this case, a relation between the change amount of the operated position and the change amount of the set value acts on change speed of parameters. For example, when the change amount of the operated position is set big, the change amount being required to change the set value by a predetermined unit amount, since the change amount of the set value is small to the operation amount by the user, the set value of a parameter changes relatively gently to the degree of operation by the user. Such a setting is suitable for minor adjustment of a parameter. While, in order to change considerably a parameter, a bigger degree of operation is required to a user. Accordingly, there may occur inconvenient situations such that operation time increases and operation is cumbersome. On the other hand, if the change amount of the operated position required to change a set value by a predetermined unit amount is set small, the change amount of the set value is made bigger to the operation amount of the user. Accordingly, the set value of the parameter changes comparatively rapidly to the degree of operation performed by the user. Although such a setting is convenient for a big change of a parameter, but is not suitable for the minor adjustment of the parameter. Although it is widely realized to adjust the relation between the above mentioned change amounts as the user like, change during the operation is not considered.

Then, the present invention aims to provide a user interface apparatus capable of controlling appropriately a change speed of a parameter to a degree of operation for setting the parameter by a user.

### Solution to Problem

A computer user interface apparatus as one aspect of the present invention is a computer user interface apparatus which is configured to present to a user, information (30) to be a rough indication for making the user recognize a setting state of a parameter, the parameter being referenced in computer arithmetic processing, and to set the parameter according to a setting operation (as one example, a drag operation) accompanying change of an operated position (Pa) operated by the user, comprising: an operation detecting device (17) which is configured to detect the operated position by the user; and a computer (10), the computer executing a computer program to function as a parameter setting device (20, S1 to S13) which is configured to change a set value (Pg) of the parameter according to a change amount(ΔY) of the operated position detected by the operation detecting device (17), wherein the computer functions as the parameter setting device which is provided with a relation controlling device (26, S9) which is configured to change a relation between the change amount of the operated position and a change amount of the set value of the parameter, according to elapsed time (t) from a predetermined reference time which is set in relation to the setting operation.

A parameter control method as one aspect of the present invention is a parameter control method being applied to a computer user interface apparatus which is configured to present to a user, information (30) to be a rough indication for making the user recognize a setting state of a parameter to be referenced in arithmetic processing of a computer (10), to detect by a predetermined operation detecting device (17), a setting operation (as one example, a drag operation) accompanying change of an operated position (Pa) operated by the user, and to set the parameter according to a detection result of the operation detecting device, wherein the parameter control method makes the computer execute a step (S1 to S13) of changing a set value (Pg) of the parameter according to a change amount (ΔY)of the operated position detected by the operation detecting device (17), the step of changing the set value further including a step (S9) of changing a relation between the change amount of the operated position and a change amount of the set value of the parameter according to elapsed time (t) from a predetermined reference time which is set in relation to the setting operation.

A non-transitory storage medium as one aspect of the present invention is a non-transitory storage medium storing a computer program (PG) for making a computer (10) present to a user, information (30) to be a rough indication for making the user recognize a setting state of a parameter to be referenced in computer arithmetic processing, detect by a predetermined operation detecting device (17), an setting operation accompanying change of an operated position (Pa) operated by the user, and set the parameter according to a detection result of the operation detecting device, wherein the computer program is configured to make the computer function as a parameter setting device (20, S1 to S13) which is configured to change a set value of the parameter according to a change amount (ΔY) of the operated position detected by the operation detecting device, and to make the computer further function as the parameter setting device which is provided with a relation controlling device (26, S9) which changes a relation between the change amount of the operated position and a change amount of the set value of the parameter according to elapsed time (t) from a predetermined reference time which is set in relation to the setting operation.

According to the present invention, the relation between the change amount of the operated position operated by the user (the change amount can be considered as an operation amount of the user performed within a certain time) and the change amount of the set value of the parameter changes according to the elapsed time from the predetermined reference time. Accordingly, while the user is performing the setting operation, it is possible to set the relation so that the parameter changes rapidly in a step where big change of the parameter is appropriate, and also possible to set the relation so that the parameter changes slowly in a step where minor adjustment of the parameter is appropriate. Thereby, it is possible to realize the computer user interface apparatus capable of controlling appropriately the change speed of the parameter to the setting operation of the user.

In the present invention, the relation controlling device may be configured to change the relation by increasing or decreasing a criterion value (Vc) set as a change amount of the operated position, the change amount being required to make the parameter change by a predetermined one unit. According to this embodiment, when the criterion value is increased, it is possible to make the set value of the parameter change comparatively slowly, and when the criterion value is decreased, it is possible to make the set value of the parameter change comparatively rapidly.

Further, the relation controlling device may be configured to change the relation by increasing the criterion value as the elapsed time increases. According to this embodiment, in a step when the elapsed time from the criterion time relating to the setting operation is comparatively short, since the set value of the parameter changes comparatively rapidly, it is possible to set roughly the parameter in a short time. On the other hand, in a step when the elapsed time increases to some degree, since the set value of the parameter becomes to change comparatively slowly, it is possible to perform easily the minor adjustment of the parameter.

In the present invention, the computer user interface apparatus may further comprise a display device (15), and the computer may further function as a set value presenting device (10, 32) which is configured to present as the information to be the rough indication, the set value of the parameter in a predetermined display mode to the user, by using the display device. Thereby, the user is allowed to perform the setting operation while checking the set value of the parameter.

In the present invention, the parameter setting device may be configured to set the parameter which the computer references when executing the computer arithmetic processing for proceeding with a predetermined game. Thereby, it is possible to make the user set the parameter efficiently in a game. Accordingly, the operation performance is improved.

In the above explanations, for making it easy to understand the present invention, the referential marks of the attached figures are added with parentheses. However, it should be understood that this does not mean that the present invention is limited to the illustrated embodiment.

### BRIEF DESCRIPTION OF DRAWINGS

FIG. 1 is a diagram showing a whole configuration of a game system including a game machine where the computer user interface apparatus according to one embodiment of the present invention is applied.

FIG. 2 is a functional block diagram in a main portion of the game machine shown in FIG. 1.

FIG. 3 is a diagram showing a mechanism for setting a gauge volume by the computer user interface apparatus.

FIG. 4 is a functional block diagram showing a detailed configuration of a gauge volume setting portion shown in FIG. 2.

FIG. 5 is a flowchart showing procedure in gauge volume setting processing.

FIG. 6 is a diagram showing a variation with respect to a function for calculating a criterion value.

FIG. 7 is a diagram showing another variation with respect to a function for calculating the criterion value.

FIG. 8 is a diagram showing further another variation with respect to a function for calculating the criterion value.

### DESCRIPTION OF EMBODIMENTS

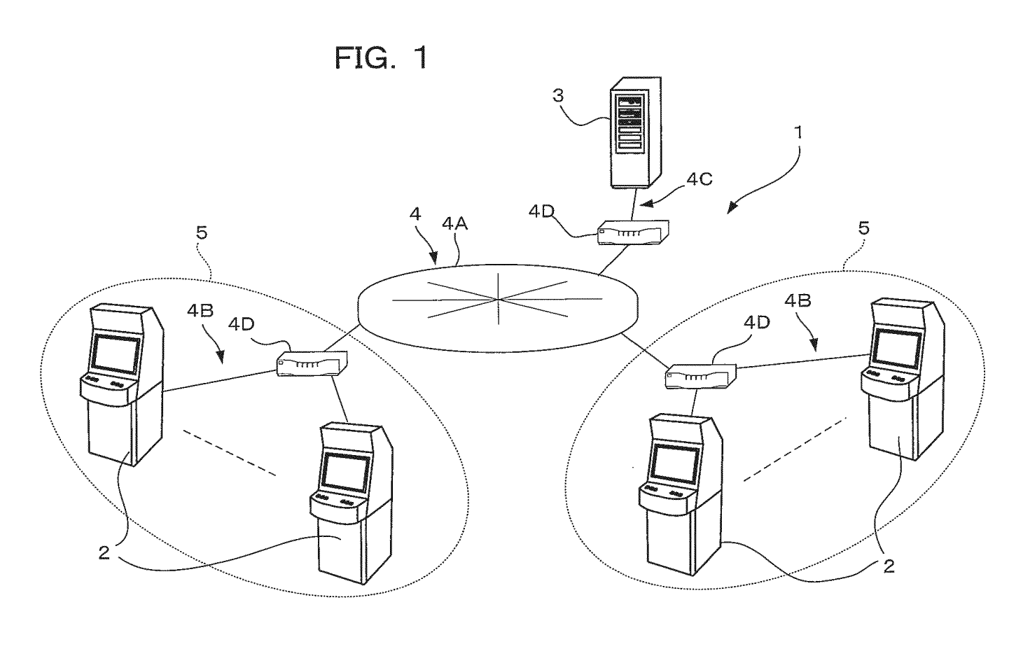

Hereinafter, one embodiment of the present invention will be described in reference to attached drawings. The present embodiment is an example where an interface apparatus according to the present invention is applied to a game machine constituting a part of a game system using a network. First, a brief overview of the game system will be explained using FIG. 1. The game system 1 comprises a plurality of game machines 2 each allowing a user to play a game, and a center server as a server apparatus which provides various services to the game machines 2. The game machines 2 and the center server 3 are connected communicably to each other via a network 4. The game machine 2 is a game machine for commercial use (business use), which is, for example, installed into a facility such as a store 5 to allow a user to play a game in exchange of a game-play charge within a range depending on the game-play charge. However, in the present invention, as the game machine, not only a game machine for commercial use, but also various personal terminal apparatuses such as a game machine for home use, a portable game machine, a portable telephone, a tablet type terminal, and a personal computer may be used.

The center server 3 may be configured as a single server unit, or may be configured as a combination of a plurality of server units. Also, the center server 3 may be configured as one logical server apparatus using the cloud computing. As the services provided by the center server 3, there are, for example, a service that the central server 3 receives identification information for a user from the game machine 2 to verify the user and receives from the game machine 2 game-play data where a game-play result of the user is memorized and stores the game-play data, or provides the game-play data to the game machine 2, a service that when plural users are going to play a common game via the network 4, the central server 3 matchmakes the users, and a service that the central server 3 updates a computer program and data stored in the game machine 2 via the network 4. As one example, the network 4 is configured by connecting the internet 4A and each of the LANs 4B and 4C through via a respective router 4D, the LAN 4B including the game machines 2 and the LAN 4C including the center server 3.

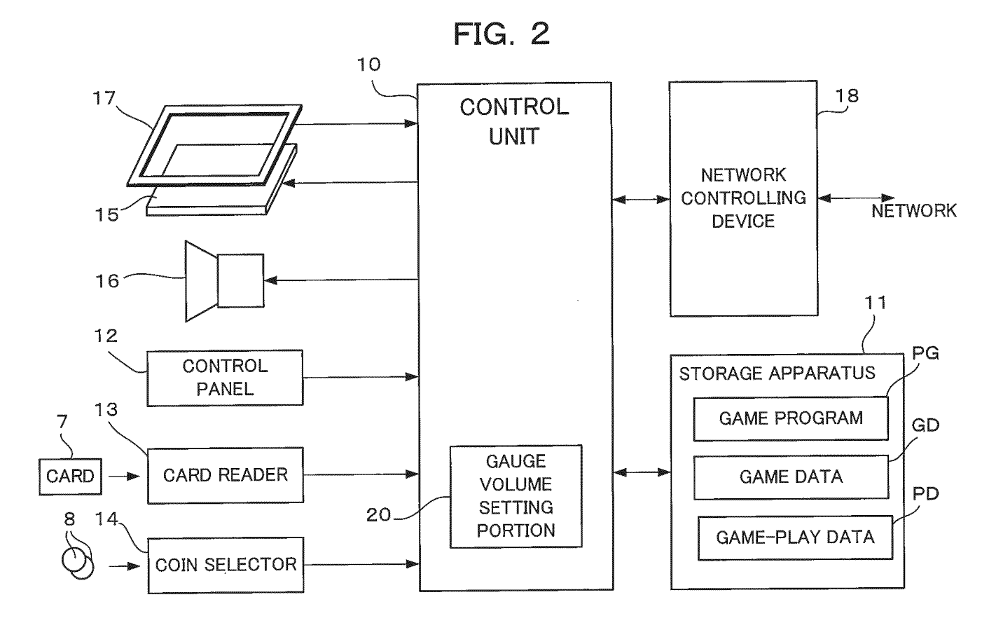

Next, in reference to FIG. 2, a main portion of a control system of the game machine 2 will be explained. The game machine 2 comprises a control unit 10 and a storage apparatus (a storage device) 11. The control unit 10 is configured as a computer where combined are a micro processor and peripheral devices including internal storages (a ROM and a RAM) necessary for operations of the microprocessor. The storage apparatus 11 is a storage apparatus capable of storing memories, such as a hard disc storage apparatus. The storage apparatus 11 stores a game program PG to be executed by the control unit 10, and game data GD and game-play data PD to be referenced by the program PG. The game program PG is an application program which operates on an operating system of the game machine 2 to allow a user to play a predetermined game at the game machine 2. The game data GD includes various kinds of data such as image data necessary for drawing game image in accordance with the game program PG, and music data necessary for reproducing music in the game. The game-play data PD is data where a game-play result of the user is stored in association with predetermined identification information. As mentioned above, the game-play data PD is stored on the center server 3, and, in reply to a requirement from a user of the game machine 2, the game-play data PD is read into the game machine 2 of the user and stored in the storage apparatus 11.

The game machine 2 is provided with, as input devices to the control unit 10, a control panel 12, a card reader 13 and a coin selector 14. The control panel 12 is a panel where collected are operation devices provided to a chassis of the game machine 2, such as push switches and operation levers. The card reader 13 reads out predetermined information from a card 7 possessed by a user to provide the information to the control unit 10. The card 7 includes a storage medium where a card ID unique for each card is stored. The card ID is used as the identification information when, for example, the game-play data of the user is obtained from the center server 3, the game-play data is stored in the center server 3, or the like. The coin selector 14 determines whether coins 8 of currency (or, a medal or the like as an alternative currency may be applied) are true or false, the coins 8 having been inserted by the user for paying the game-play fee from a coin insertion slot, not illustrated, and the coin selector 14 outputs to the control unit 10 information corresponding to the number of coins 8 determined as true and the money amount thereof. The game machine 2 is provided with, as output devices to the control unit 10, a display device 15 for outputting image and a speaker 16 for outputting sound. The display device 15 is a flat panel display, such as a liquid-crystal display panel display and an organic EL panel display.

On the display surface of the display device 15 of the game machine 2 (hereinafter, sometimes referenced as “the monitor screen”.), a touch panel input device 17 is provided as a further input device to the control unit 10. The touch panel input device (hereinafter, abbreviated as “the touch panel”.) 17 is provided as an operation detecting device which detects as an operated position, a position which a user is touching on the monitor screen, and outputs a signal corresponding to the operated position. The operated position of the user is represented as, for example, coordinate values of a two-dimensional coordinate system set with respect to a lateral direction and a longitudinal direction of the monitor screen. As one example of the touch panel 17, employed is an optical touch panel which scans a detecting area on the monitor screen in a direction parallel to the monitor screen by using a predetermined detecting light (infrared light, for example), and detects a position where the detecting light is interrupted. Another type touch panel such as pressure-sensitive type one may be employed. Further, as the touch panel 17, a tree-dimensional touch panel may be employed, the three-dimensional touch panel capable of detecting not only a position touched by a user on the monitor screen, but also a position of a finger of the user or the like with respect to a direction perpendicular to the monitor screen. In addition, to the control unit 10, a network controlling device 18 is connected. The network controlling device 18 is a communication controlling unit which connects the control unit 10 with the network 4, and controls establishment of communication procedure and processing necessary for receiving and sending data, for communicating with the center server 3 or the other game machine 2.

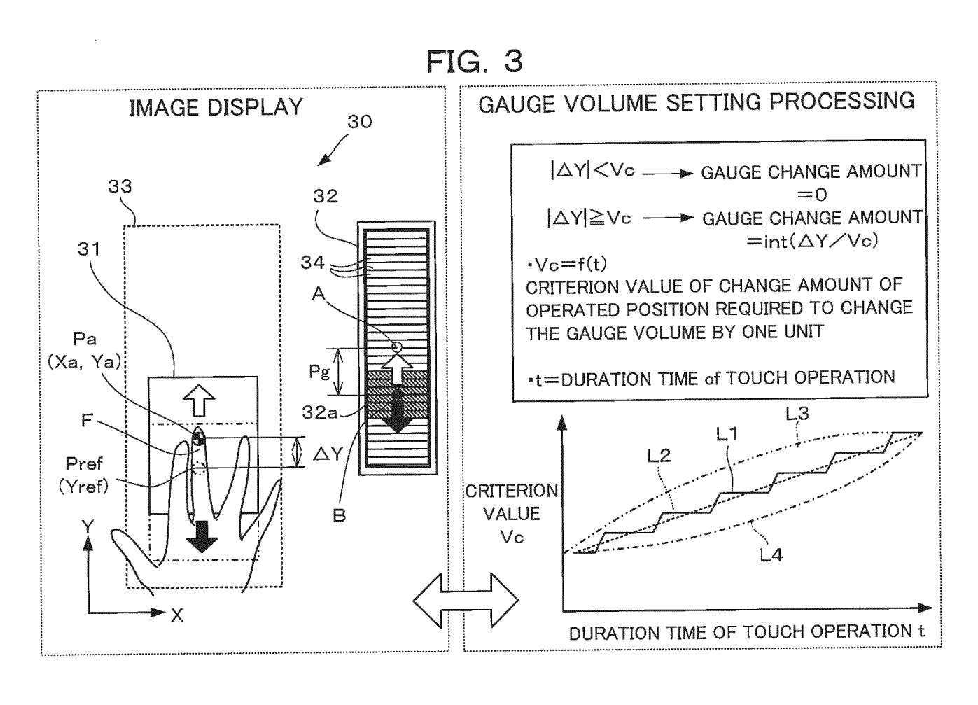

The control unit 10 is provided with a gauge volume setting portion 20. The gauge volume setting portion 20 is a logical device realized by combination of hardware resources of the control unit 10 and the game program PG as software. The gauge volume setting portion 20 is responsible for processing necessary for setting a gauge volume as a parameter which is referenced in a predetermined arithmetic processing executed by the control unit 10 according to the game program PG. In the present embodiment, a user interface apparatus for setting the gauge volume is configured by a combination of the processing of the gauge volume setting portion 20, a predetermined image which is displayed on the display device 15 by the control of the control unit 10, and a function of detecting the operated position by the touch panel 17. Hereinafter, in reference to FIG. 3, the mechanism that the gauge volume is set by the user interface apparatus will be described.

As shown in FIG. 3, the user interface apparatus realizes the setting of the gauge volume by the combination of the display of an operation portion 30 which is displayed on a screen of the display portion 15 (see FIG. 2) and gauge volume setting processing based on the detection result of the operated position of a user in the operation portion 30. First, the operation portion 30 will be explained. The operation portion 30 is a portion which presents image information to be a rough indication for making a user recognize the setting state of the gauge volume. In the operation portion 30, displayed are an object 31 as an operation object image for the user and a gauge 32 as a set value image showing the present set value of the gauge volume. When the user performs a drag operation with his/her finger F to move the object 31 upward (the direction indicated by a white arrow) or downward (the direction indicated by a black arrow), the object 31 moves like following the finger and the set value of the gauge volume changes, and along with the change, the display of the gauge 32 also changes. The motion of the object 31 following the finger F and the change of the gauge 32 according to the gauge volume are controlled appropriately by the control unit 10. In addition, an operation range frame 33 may be further displayed for showing a range where the user can operate the object 31. Alternatively, instead of the image of the object 31, a physical body (for example, a card where the contents of the object 31 are printed) may be set as the operation object, and when the user puts the body on the operation portion 30 and moves the body with his/her finger F, the change amount with respect to the position of the body may be detected by an operation detecting device, and while the set value of the gauge volume being changed according to the change amount, the display of the gauge 32 may be changed along with the change of the set value.

The outer shape of the gauge 32 is vertically-long rectangular shape. In the gauge 32, a lot of segments 34 are arranged sequentially in an up-down direction (that is, an operation direction of the object 31). As shown with a hatching area in the drawing, the state (the color and the lightness value) of one part of segments 34 is shown so as to be different from the state of the other part of segments 34 to display an indication portion 32a in the gauge 32. The position of the indication portion 32a indicates the set value of the gauge volume. For example, when the center points of the gauge 32 and the indication portion 32a with respect to the up-down direction are set to be points A and B respectively, a distance Pg between the points A and B corresponds to the gauge volume. Further, the direction where the representative point B exists with respect to the representative point A indicates whether the gauge volume is positive or negative. That is, there are a positive gauge volume and a negative gauge volume. However, the representative point A is not limited to the above example, and the other point such as the lowest end of the gauge 32 may be set as the representative point A. Also, the position of the representative point B may be set appropriately as a position for representing the indication portion 32a.

The gauge volume is referenced in appropriate arithmetic processing in a game to be executed by the control unit 10. For example, in a case where actions of a character in the game, the character being used in the game by a user, are determined by arithmetic processing based on a lot of ability parameters set to the character, it is possible to make it change depending on the gauge volume which one of the ability parameters is prioritized. For example, in a case where the character attacks a competitor, the arithmetic processing is executed in reference to the gauge volume, so that: as the gauge volume is set bigger with respect to a positive direction, the probability that the character performs a trick whose attack effect is high while the success rate being low, becomes higher; and as the gauge volume is set bigger with respect to a negative direction, the probability that the character selects a trick whose attack effect is low while the success rate being high. In such a case, the object 31 may be displayed as an image of a card or the like where the character is drawn.

On the other hand, in the gauge volume setting processing, in reply to the operation to the operation portion 30 by the user, the set value of the gauge volume is controlled as the follows. In the following explanation, it is assumed that a position in the operation portion 30 is specified in an XY orthogonal coordinate system, and a moving direction of the object 31 coincides with the Y-axis direction. Further, it is assumed that a user moves his/her finger F so that the object 31 moves from a position shown as an imaginary line to a position shown as a solid line. A position, which the user was touching with his/her finger F before the move, is set as a reference position Pref, and a position touched after the move by the finger F is set as the present position Pa. A distance with respect to the Y-axis direction, which is obtained by subtracting the Y-coordinate value Yref of the reference position Pref from Y-coordinate value Ya of the present position Pa, is set as a change amount ΔY (=Ya−Yref) of the operated position. The change amount ΔY may be specified using an appropriate unit as long as the change amount ΔY and the distance correlate with each other. As one example, the change amount ΔY can be specified by the number of dots using one pixel (one dot) of the display device 15 as a unit.

In the gauge volume setting processing, the change amount ΔY of the operated position is calculated according to the position information detected by the touch panel 17, and the magnitude of an absolute value of the change amount ΔY of the operated position is compared to a predetermined criterion value Vc. The criterion value Vc is a criterion value of the change amount ΔY of the operated position, which is required for making the gauge volume Pg change by one unit (which corresponds to one segment 34 here). When the absolute value of the change amount ΔY is less than the criterion value Vc, the change amount of gauge volume (the gauge change amount) is determined as zero. That is, the gauge volume does not change. On the other hand, when the absolute value of the change amount ΔY is equal to or more than the criterion value Vc, a value of the integer part of the quotient obtained by dividing the positional change amount ΔY by the criterion value Vc is calculated as the gauge change amount. Thereby, each time when the user moves his/her finger F by the criterion value Vc, the gauge volume changes by one unit at a time.

The above mentioned criterion value Vc functions as a parameter for determining a relation between the change amount of the operated portion of the user and the change amount of the gauge volume. If the criterion value Vc is big, the gauge volume changes comparatively slowly to the drag operation of the user. In this case, while the minor adjustment of the gauge volume is executed easily, it takes a comparative long time to make the gauge volume change a lot. On the other hand, if the criterion value Vc is small, the gauge volume changes comparatively rapidly to the drag operation of the user. In this case, while it takes shorter time to make the gauge volume change a lot, the minor adjustment of the gauge volume becomes difficult. In order to make effective adjustment of the gauge volume possible in such a conflicting situation mentioned above, in the present embodiment, the criterion value Vc is made to change during the operation of the user. That is, in the present embodiment, the time point when the user starts the touch operation to the object 31 is set as the reference time, and a function f(t) is set, the function f(t) having, as a variable number, duration time t of the touch operation from the reference time, and thereby the criterion value Vc is made to change. The function f(t) is set, for example, so that as shown by a solid line L1 in FIG. 3, each time when the duration time t increases by a predetermined amount, the criterion value Vc becomes bigger in a stepwise fashion. The change of the criterion value Vc shown by the solid line L1 is one example that the criterion value Vc is made to increase in a stepwise fashion for each predetermined time by using a linear function shown by a broken line L2 as a base. The function f(t) is not only the one obtained by using such a linear function as a base, but also may be the linear function itself shown by the solid line L1, or may be the one obtained by using a sine function shown by an imaginary line L3 or L4 as a base.

As mentioned above, in a case where the criterion value Vc is made to increase as the duration time t increases, in an early step after the user has started the drag operation for setting the gauge volume, the gauge volume changes comparatively a lot with a small operation amount, and the change speed of the gauge volume becomes gradually slow according to the duration time when the user continues the drag operation. Accordingly, the user is allowed to adjust roughly the gauge volume for a short time after starting the operation, and after that, the user is allowed to perform the minor adjustment of the gauge volume. Thereby, it is possible to efficiently adjust the gauge volume.

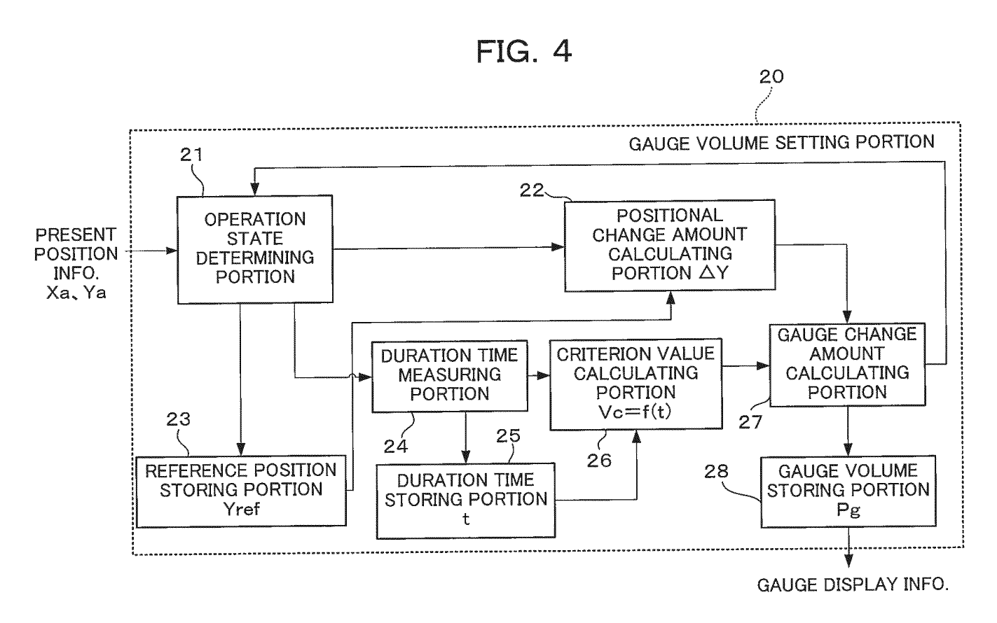

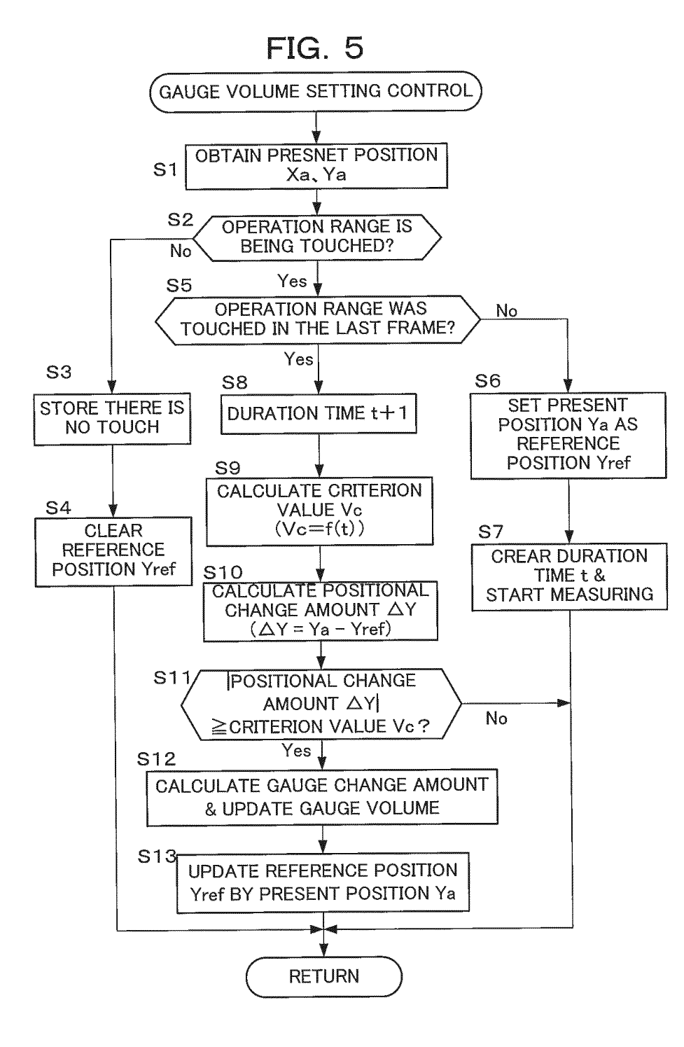

Next, in reference to FIGS. 4 and 5, more specific construction and processing will be explained with respect to the setting of the gauge volume. FIG. 4 is a functional block diagram showing a detailed construction of the gauge volume setting portion 20 shown in FIG. 2. Hereinafter, the reference signs shown in FIG. 3 are used as appropriate. To the gauge volume setting portion 20, information (the coordinate values Xa and Ya) of the present position Pa which is being touched by the finger F of the user is inputted in a predetermined cycle. The cycle is a rewriting cycle (that is, the frame rate) of the game image which should be displayed on the display device 15. The information of the present position Pa is given to an operation state determining portion 21. The operation state determining portion 21 monitors the information of the present position Pa to determine whether the user is continuing the touch operation to a predetermined operation range set to the object 31. In a case where the touch operation is being continued, the operation state determining portion 21 provides the Y-coordinate value Ya of the present position Pa to a positional change amount calculating portion 22, and instructs the positional change amount calculating portion 22 to calculate the change amount ΔY. In a case where the touch operation is not being continued, the operation state determining portion 21 clears the Y-coordinate value Yref of the reference position Pref stored in a reference position storing portion 23. Further, in a case where the touch operation is started newly, the operation state determining portion 21 sets and stores in the reference position storing portion 23, the Y-coordinate value Ya of the present position Pa as the Y-coordinate value Yref of the reference position Pref.

In addition, the operation state determining portion 21 provides the determination result to a duration time measuring portion 24. According to the determination result from the operation state determining portion 21, the duration time measuring portion 24 uses a time point when the touch operation was started as the reference time, and measures the duration time t from the reference time, and stores the measurement value in a duration time storing portion 25. That is, in a case where the determination result indicating a start of the touch operation is provided from the operation state determining portion 21, the duration time measuring portion 24 clears the duration time t in the duration time storing portion 25, and starts measuring the duration time t from the initial value. In a case where the touch operation is being continued, the duration time measuring portion 24 increases the duration time t stored in the duration time storing portion 25 by a predetermined amount of units and instructs the criterion value calculating portion 26 to calculate the criterion value Vc. The duration time t is specified as the number of frames by using one frame as a unit.

In a case where the positional change amount calculating portion 22 is instructed to calculate the change amount ΔY by the operation state determining portion 21, the positional change amount calculating portion 22 calculates the positional change amount ΔY by using the Y-coordinate value Ya of the present position Pa which is provided from the operation state determining portion 21 and the Y-coordinate value Yref of the reference position Pref stored in the reference position storing portion 23. The positional change amount ΔY is a difference between the Y-coordinate value Ya and the Y-coordinate value Yref. On the other hand, when a criterion value calculating portion 26 is instructed to calculate the criterion value Vc by the duration time measuring portion 24, the criterion value calculating portion 26 put the duration time t stored in the duration time storing portion 25 into the function f(t) to calculate the criterion value Vc.

The positional change amount ΔY calculated by the positional change amount calculating portion 22 and the criterion value calculated by the criterion value calculating portion 26 are provided to a gauge change amount calculating portion 27. The gauge change amount calculating portion 27 compares the magnitudes of the absolute value of the positional change amount ΔY and the criterion value Vc. In a case where the absolute value of the change amount ΔY is less than the criterion value Vc, the gauge change amount is calculated to become zero. On the other hand, in a case where the absolute value of the change amount ΔY is equal to or more than the criterion value Vc, the gauge change amount calculating portion 27 calculates the gauge change amount according to the arithmetic expression shown in FIG. 3, and updates the gauge volume Pg stored in the gauge volume storing portion 28 so that set as a new gauge volume Pg is a value obtained by adding the gauge change amount calculated to the gauge volume Pg stored in a gauge volume storing portion 28. In a case where the gauge volume Pg is updated, the gauge change amount calculating portion 27 notifies an operation state determining portion 21 of the calculation result. In reply to the notification, the operation state determining portion 21 updates the Y-coordinate value Yref of the reference position storing portion 23 so that Y-coordinate value Ya of the present position Pa is set as a Y-coordinate value Yref of a new reference portion Pref. The gauge volume Pg stored in the gauge volume storing portion 28 is referenced when the control unit 10 controls the display of the gauge 32. By the display control of the control unit 10 and the display of the gauge 32, a set value presenting device of the present invention is realized. The gauge volume Pg is referenced in arithmetic processing of a game by the control unit 10, for example, processing for determining motions of a character.

Next, in reference to FIG. 5, the procedure of gauge volume setting control processing executed by the gauge volume setting portion 20 will be explained. The processing in FIG. 5 is executed repeatedly for each frame in time with the rewriting cycle of the game image displayed on the display device 15. When the gauge volume setting portion 20 starts the processing shown in FIG. 5, first, information of the present position Pa (the coordinates Xa and Ya in FIG. 3) is taken by the operation state determining portion 21 (step S1), and next, it is determined by the operation state determining portion 21 whether the finger F of the user is touching a predetermined operation range in reference to the information taken (step S2). The operation range is a range which is set to the object 31 as a position which the user should touch with his/her finger F. The whole or a part of the object 31 may be set as the operation range, or a range including the object 31 and a predetermined area of the periphery of the object 31 may be set as the operation range.

In step S2, in a case where it is determined that the user is not touching the operation range, the operation state determining portion 21 stores the determination result of the operation state of this time, that it is determined that there is no touch (step S3). After that, the Y-coordinate value Yref of the reference position Pref stored in the reference position storing portion 23 is cleared by the operation state determining portion 21 (step S4). After the processing of step S4 completes, the gauge volume setting portion 20 ends the processing shown in FIG. 5 of this time. On the other hand, in step S2, in a case where it is determined that the user is touching the operation range, it is determined by the operation state determining portion 21 whether the operation range was being touched also at the moment of the last processing of FIG. 5 (that is, at the moment of the last frame) (step S5). In a case where the processing of step S3 was executed in the last processing, a negative determination is obtained in step S5, and in other cases, a positive determination is obtained in step S5.

In a case where the negative determination is obtained in step S5, the operation state determining portion 21 sets the Y-coordinate value Yref of the reference position Pref stored in the reference position storing portion 23 to the Y-coordinate value Ya of the present position Pa (step S6). After that, the duration time t stored in the duration time storing portion 25 is cleared by the duration time measuring portion 24, and further, it is started newly to measure the duration time by the duration time measuring portion 24 (step S7). When the processing of step S7 completes, the gauge volume setting portion 20 ends the processing shown in FIG. 5 of this time.

On the other hand, in step S5, in a case where it is determined that the operation range was being touched also at the moment of the last frame, the duration time is measured by the duration time measuring portion 24 so that 1 is added to the duration time t stored in the duration time storing portion 25 (step S8). After that, the criterion value Vc is calculated by the criterion value measuring portion 26 according to the duration time t stored in the duration time storing portion 25 (step S9). Further, based on the Y-coordinate value Ya of the present position Pa taken by the operation state determining portion 21 and the Y-coordinate value Yref of the reference position Pref stored in the reference position storing portion 23, the positional change amount ΔY with respect to the touch operation of the user is calculated by the positional change amount calculating portion 22 (step S10). Subsequently, by the gauge change amount calculating portion 27, the magnitudes of the absolute value of the change amount ΔY and the criterion value Vc are compared (step S11). When the absolute value of the change amount ΔY is equal to or more than the criterion values, the gauge change amount calculating portion 27 calculates the gauge change amount according to the arithmetic expression shown in FIG. 3, calculates a new gauge volume according to the gauge change amount, and updates the gauge volume Pg stored in the gauge volume storing portion 28 using the gauge volume calculated (step S12).

When the gauge volume Pg is updated in step S12, the operation state determining portion 21 updates the Y-coordinate value Yref of the reference position Pref stored in the operation state storing portion 23 so as to be set to the Y-coordinate value Ya of the present position Pa taken by the operation state determining portion 21 (step S13). When the processing of step S13 completes, the gauge volume setting portion 20 ends the processing shown in FIG. 5.

According to the above processing, when the user starts the touch operation to the operation range set to the object 31, while an affirmative determination is obtained in step S2, a negative determination is obtained in step S5. In step S6, the Y-coordinate value Ya of the touched position at the time point when the touch operation is started is set as the Y-coordinate value Yref of the reference position Pref, and in step S7, started is the measurement of the duration time t of the touch operation by setting the time point of starting the touch operation as a reference time. After that, when the user continues the touch operation, the affirmative determinations are obtained in step S2 and step S5, while the measurement of the duration time t is kept on in step S8, the criterion value Vc corresponding to the duration time t is calculated in step S9 and subsequently the positional change amount ΔY of the touch operation is calculated in step S10. Based on the calculation results, in steps S11 and S12, the change amount of the gauge volume Pg is calculated and the gauge volume Pg is updated according to this calculation result.

When the gauge volume Pg is updated, the Y-coordinate value Ya of the present position Pa at the moment of the update is set as a Y-coordinate value Yref of a new reference position Pref. When the next processing shown in FIG. 5 is executed, based on the Y-coordinate value Yref of the new reference position Pref, the change amount of the gauge volume is calculated and the gauge volume is updated. Accordingly, in a case where the user continues the drag operation, each time when the operation amount (the absolute value of the change amount ΔY) reaches the criterion value Vc, the gauge volume Pg is increased or decreased by one unit (corresponding to a value of one segment 34) at a time. Further, the criterion value Vc increases gradually as the duration time t increases by the function f(t) having the duration time t as a variable number. Accordingly, the gauge volume changes comparatively rapidly at the beginning after the user starts the drag operation, and as the drag operation is continued, the change of the gauge volume becomes slow gradually. When the user remove his/her finger F from the operation range set to the object 31, a negative determination is obtained in step S2, and the Y-coordinate Yref of the reference position Pref is cleared in step S4. After that, when the user touches the operation range again, while an affirmative determination is obtained in step S2, a negative determination is obtained in step S5, and the update of the gauge volume is resumed using the position where the touch operation is newly performed as the reference position Pref.

In the above embodiment, the gauge volume setting portion 20 functions as a parameter setting device of the present invention by executing the processing steps S1 to S13 shown in FIG. 5. Especially, the criterion value calculating portion 26 of the gauge volume setting portion 20 functions as a relation controlling device of the present invention by executing the processing of step S9 shown in FIG. 5.

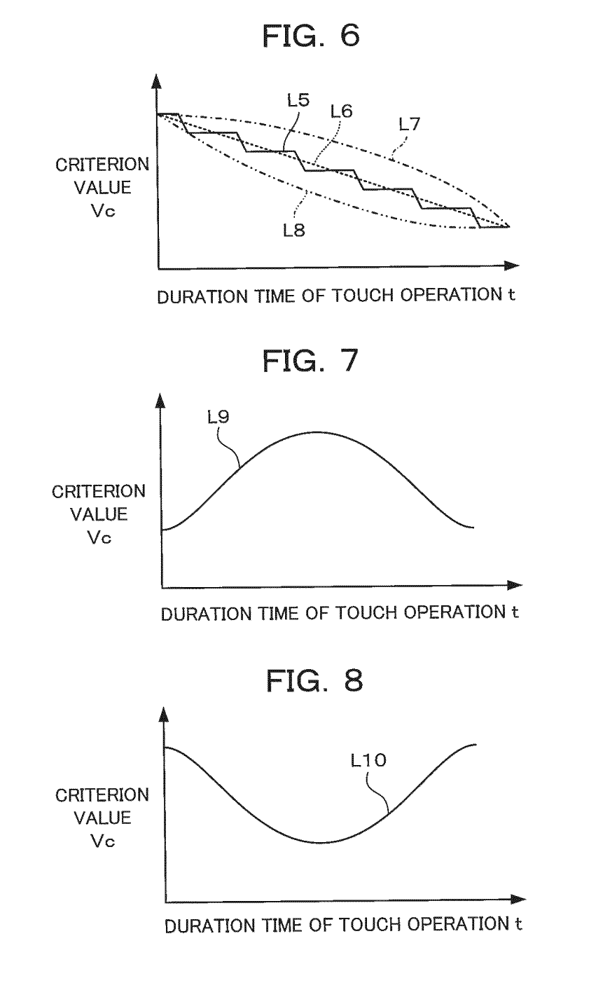

The present invention is not limited to the above embodiment, and may be executed by embodiments modified or changed as appropriate. For example, though the criterion value Vc is increased gradually in accordance with the increase of the duration time t in the above embodiment, a change state of the criterion value Vc can be varied as appropriate. For example, as shown by a solid line L5 in FIG. 6, the criterion value Vc may be decreased gradually in accordance with the increase of the duration time t. The solid line L5 shown in FIG. 6 is one example that the criterion value Vc is decreased in a stepwise fashion for each predetermined time by using a linear function shown by a broken line L6 as a base. The function f(t) is not only a case obtained by using such a linear function as a base, but also may be the linear function itself shown by the broken line L6, or also may be obtained by using a sine function shown by an imaginary line L7 or L8 as a base. The change state of the criterion value shown in FIG. 6 is preferable for a case, for example, that the user is required to adjust carefully a parameter in the beginning of the drag operation started by the user, and after the adjustment, required to change the parameter big. In addition, the function for determining the criterion value Vc may be a function in which the criterion value becomes small in the beginning and the ending of the operation and becomes big in the middle of the operation as shown by a solid line L9 in FIG. 7, or crossly, may be a function in which the criterion value becomes big in the beginning and the ending of the operation and becomes small in the middle of the operation as shown by a solid line L10 in FIG. 8. Further, the correlation between: the positional change amount caused by the operation which the user performs in accordance with an operation condition for setting a parameter; and the change amount of the set value of the parameter, may be changed as appropriate.

In the above embodiment, the time point when the user starts the touch operation is set as the reference time, and the duration time of the touch operation from the reference time is measured as the elapsed time. However, the present invention is not limited to such an embodiment. For example, in a case where after a user performs the touch operation, the operated position changes by a predetermined amount or more, this may be regarded as the start of the drag operation, and the time point regarded as the start of the drag operation may be set as the reference time. As the elapsed time from the reference time, in the above embodiment, the duration time of the touch operation is measured, and when the touch operation is discontinued once the duration time is reset to restart the measurement. However, the measurement of the elapsed time is not limited to such an embodiment and appropriate variations can be applied. For example, the following variation may be applied. It is determined whether the drag operation is continued or not and the duration time thereof is measured as the elapsed time. In a case where the elapsed time is measured from the reference time with respect to the touch operation or the drag operation, even if the touch operation or the drag operation is discontinued once, when the operation is resumed within a predetermined window time, the measurement of the elapsed time may be continued without changing the reference time. In this case, the measurement of the elapsed time may be continued even in the window time, or the measurement of the elapsed time may be discontinued once in the window time. Further, it is enough, if the reference time is set in association with the setting operation of the user. For example, as mentioned above, the time point when some time has been elapsed after the start of the operation may be set as the reference time. Alternatively, the time point when the setting operation is instructed to the user may be set as the reference time, and the measurement of the elapsed time may be started from the time point regardless whether the user has started the operation or not.

In the above embodiment, as the information to be the rough indication which makes the user recognize the setting state of a parameter, the object 31 as an image of the operation object and the gauge 32 indicting the gauge volume are displayed. However, the information to be the rough indention is not limited to these examples, and appropriate variations may be applied. For example, only the gauge 32 may be displayed. Crossly, only the object 31 may be displayed. In a case where only the gauge 32 is displayed, a touch panel may be provided in an area where the gauge 32 is displayed or a neighborhood of the area, and the touch operation of the user may be detected. In this case, even if the segment 34 of the gauge 32 is considerably small in comparison to the magnitude of the finger F of the user, by increasing the criterion value Vc mentioned above when the minor adjustment of the gauge volume is required, it is possible to perform easily the minor adjustment of the gauge volume. Further, even when only the object 31 is displayed, from the change of its position, the user can recognize it as the setting state whether the gauge amount as the parameter has been set comparatively big or comparatively small. Further, a display mode for presenting the set value to the user is not limited to the mode using a bar-graph like the gauge 32. The set value of the parameter may be presented in various states such as a circle graph. Display mode where the set value is presented by using numeral numbers or textual information correlating with the numeral numbers may be applied. In addition, the information to be the rough indication is not limited to the example of displaying image. For example, the presentation using sound may be applied, where the sound volume, the sound tone, and the sound color are changed in accordance with the change of the set value of the parameter.

The operation detecting device is not limited to the example of using the touch panel. It is possible to use an appropriate device as the operation detecting device, as long as the device can detect change of the operated position with respect to the setting operation by the user. For example, a physical operation detecting device may be provided as the operation detecting device, where the user is made to operate a movable operation member, such as a lever and a slider, and a signal depending on the position of the operation member is outputted. Alternatively, an operation detecting device which detects user's operation without his/her contact, for example, a device which photographs a motion of the user with a camera and based on the photograph detects a position where the user is operating, may be provided as the operation detecting device.

In the above embodiment, the change amount of the operated position which is required to change a parameter by one unit is set as the criterion value, and the relation between the change amount of the operated position and the change amount of the set value of the parameter is changed by changing the criterion value. However, the present invention is not limited to such an example. With respect to the way of changing the relation between the change amount of the operated position and the change amount of the set value of the parameter, appropriate variations may be applied. For example, the relation between the change amount of the operated position and the change amount of the set value of the parameter can be changed by the following way. In a case where the change amount of the set value of the parameter is calculated by multiplying a predetermined coefficient by the change amount of the operated position, or adding a predetermined constant number to the change amount of the operated position, the coefficient or the constant number is changed in accordance with the elapsed time.

The present invention is not only applied to a case of setting a parameter to be referenced in arithmetic processing in a game, but also can be applied to a case of setting a parameter of a computer for various kinds of use. The computer program according to the present invention may be provided in a state that the computer program is stored in a storage medium. With this storage medium, for example, by installing the computer program according to the present invention to a computer and executing the computer program, it is possible to realize a computer user interface apparatus of the present invention by using the computer. The storage medium where the computer program is recorded may be a non-transitory storage medium such as a CD-ROM.

DESCRIPTION OF REFERENCE NUMERALS

| | |
|---|---|
| 1 | a game system |
| 2 | a game machine |
| 10 | a control unit (a computer, a set value presenting device) |
| 17 | a touch panel input device (an operation detecting device) |
| 20 | a gauge volume setting portion (a parameter setting device) |
| 26 | a criterion value calculating portion (a relation controlling device) |
| 30 | an operation portion (information to be a rough indication) |
| 31 | an object |
| 32 | a gauge |
| 32a | an indication portion |

What is claimed is:

1. A computer user interface apparatus which is configured to present to a user, information to be a rough indication for making the user recognize a setting state of a parameter, the parameter being referenced in computer arithmetic processing, and to set the parameter according to a setting operation accompanying change of an operated position operated by the user, comprising: an operation detecting device which is configured to detect the operated position by the user; and a computer, the computer executing a computer program to function as
a parameter setting device which is configured to change a set value of the parameter according to a change amount of the operated position detected by the operation detecting device, wherein
the computer functions as the parameter setting device which is provided with a relation controlling device which is configured to change a relation between the change amount of the operated position and a change amount of the set value of the parameter, according to elapsed time from a predetermined reference time which is set in relation to the setting operation.

2. The computer user interface apparatus according to claim 1, wherein
the relation controlling device is configured to change the relation by increasing or decreasing a criterion value set as a change amount of the operated position, the change amount being required to make the parameter change by a predetermined one unit.

3. The computer user interface apparatus according to claim 2, wherein
the relation controlling device is configured to change the relation by increasing the criterion value as the elapsed time increases.

4. The computer user interface apparatus according to claim 1, further comprising a display device, wherein
the computer further functions as a set value presenting device which is configured to present as the information to be the rough indication, the set value of the parameter in a predetermined display mode to the user, by using the display device.

5. The computer user interface apparatus according to claim 1, wherein the parameter setting device is configured to set the parameter which the computer references when executing the computer arithmetic processing for proceeding with a predetermined game.

6. A parameter control method being applied to a computer user interface apparatus which is configured to present to a user, information to be a rough indication for making the user recognize a setting state of a parameter to be referenced in arithmetic processing of a computer, to detect by a predetermined operation detecting device, a setting operation accompanying change of an operated position operated by the user, and to set the parameter according to a detection result of the operation detecting device, wherein
the parameter control method makes the computer execute a step of changing a set value of the parameter according to a change amount of the operated position detected by the operation detecting device,
the step of changing the set value further including a step of changing a relation between the change amount of the operated position and a change amount of the set value of the parameter according to elapsed time from a predetermined reference time which is set in relation to the setting operation.

7. A non-transitory storage medium storing a computer program for making a computer present to a user, information to be a rough indication for making the user recognize a setting state of a parameter to be referenced in computer arithmetic processing, detect by a predetermined operation detecting device, an setting operation accompanying change of an operated position operated by the user, and set the parameter according to a detection result of the operation detecting device, wherein
the computer program is configured to make the computer function as a parameter setting device which is configured to change a set value of the parameter according to a change amount of the operated position detected by the operation detecting device, and to make the computer further function as the parameter setting device which is provided with a relation controlling device which changes a relation between the change amount of the operated position and a change amount of the set value of the parameter according to elapsed time from a predetermined reference time which is set in relation to the setting operation.
